(19) United States
(12) Patent Application Publication
(10) Pub. No.: US 2015/0189497 A1
(43) Pub. Date: Jul. 2, 2015

(54) USER IDENTIFICATION METHOD AND APPARATUS IN MULTI-USER WIRELESS COMMUNICATION SYSTEM

(71) Applicant: Electronics and Telecommunications Research Institute, Daejeon (KR)

(72) Inventors: Yu Ro LEE, Daejeon (KR); Chang Wahn YU, Daejeon (KR); Hee Soo LEE, Daejeon (KR); Sok Kyu LEE, Daejeon (KR)

(21) Appl. No.: 14/479,134

(22) Filed: Sep. 5, 2014

(30) Foreign Application Priority Data
Dec. 30, 2013 (KR) 10-2013-0166346

(51) Int. Cl. H04W 8/18; H04W 64/00

(52) U.S. Cl. CPC H04W 8/186; H04W 64/003

(57) ABSTRACT

Provided is a user identification method and apparatus in a multi-user wireless communication system, the method including generating first identification information by reflecting masking identification (ID) information to group ID information associated with a received signal, generating second identification information based on a correspondence relationship between the generated first identification information and possible group ID (PGU) information transferred from an available access point (AP), and determining a user position based on the generated second identification information.

### CROSS-REFERENCE TO RELATED APPLICATION

This application claims the priority benefit of Korean Patent Application No. 10-2013-0166346, filed on Dec. 30, 2013, in the Korean Intellectual Property Office, the disclosure of which is incorporated herein by reference.

### BACKGROUND

1. Field of the Invention

Embodiments of the present invention relate to a user identification method and apparatus in a multi-user wireless communication system.

2. Description of the Related Art

A plurality of access points (APs) may be mutually connected through a network. In each of the APs, a plurality of stations (STAs) included in a basic service set (BSS) may individually or concurrently perform transmission and reception. In an independent basic service set (IBSS), a single STA may perform transmission and reception with another STA individually, or concurrently with a plurality of STAs.

Each STA may include a transmitter and a receiver. With respect to a transmission signal transmitted simultaneously, a transmitter included in an STA may transmit the transmission signal through a multiple-input and multiple-output (MIMO) channel, and a transmitter included in another STA not using channel information may transmit the transmission signal based on a unit matrix, for example, an identity matrix. Also, the transmitter of the STA using the channel information may determine a weight vector based on the channel information, and determine STAs and a number of STAs to be used to simultaneously transmit a transmission signal.

In a receiver of the STA may restore data transmitted through a process such as digital conversion, carrier sensing, discrete Fourier transform (DFT), and the like.

In a case of a multi-user transmission of a very high throughput-signal (VHT-SIG)-A, the STA may verify whether a packet is transmitted to the STA through a comparison to a number of space time streams (NSTS) and a group to which the STA is included, based on information on MU[3] NSTS through M[0] NSTS of B21 through B10, and group IDs of B9 through B4.

For example, when a group ID of a group including the STA is “38”, and the user position in the corresponding group is MU[1], the STA may determine that the packet is not to be transmitted to the STA and demodulation may be suspended in a case in which a group identification (ID) of the received VHT-SIG-A is not “38”. When the received VHT-SIG-A is “38”, the STA may search for a determined position, and initiate the demodulation of the packet based on the NSTS of a user position.

The STA supporting multiple users may have groups 1 through 62, and the NSTS allowed in each of the groups may be one of four. Each of Group ID=0 and Group ID=63 may indicate a single user. The STA may recognize the user position and the group ID of the group in which the STA is included, through initial control frame exchange with the AP.

When a signal having a VHT presentation protocol data unit (PPDU) format is received, the STA may compare a received group ID to a group ID on a group in which the STA is included, which is transferred from an AP through a control frame, and may simultaneously verify a user position in consideration of a case of receiving the group ID on the group in which the STA is included. The STA may have a maximum of 64 group IDs including a single user. To classify all group IDs in consideration of the user position, the STA may need to perform simultaneous or sequential comparisons. When a simultaneous comparison is performed, a number of comparators may increase. When a sequential comparison is performed, hardware latency may increase due to verification time requirements.

### SUMMARY

According to an aspect of the present invention, there is provided a user identification method in a multi-user wireless communication system, the method including generating first identification information by reflecting masking identification (ID) information to group ID information associated with a received signal, generating second identification information based on a correspondence relationship between the generated first identification information and possible group ID (PGU) information transferred from an available access point (AP), and determining a user position based on the generated second identification information.

The determining may include generating a position comparison bit based on the generated second identification information and a masking bit.

The determining may further include determining the user position based on the generated position comparison bit.

The user identification method may further include storing and maintaining the PGU information transferred from the available AP.

The storing may include storing a combination of a user position and PGU information transferred to an AP through a control frame, in a form of a bitstream.

The generating of the first identification information may include performing an n-bit shift operation on the group ID information associated with the received signal, comparing the masking ID information and the group ID information on which the n-bit shift operation is performed, on a bit by bit basis, and generating the first identification information based on a result of the comparing.

The generating of the second identification information may include determining whether the generated first identification information is identical to the PGU information on a bit by bit basis, and generating the second identification information based on a result of the comparing.

The determining may include verifying whether “1” is present among bits included in the generated second identification information, and determining, when “1” is present, that a user position corresponding to at least one of the PGU information and the group ID information associated with the received signal is present.

The determining may include determining, when “1” is absent, that the user position corresponding to the PGU information and the group ID information associated with the received signal is absent, and terminating reception of a signal based on a result of the determining.

The determining may further include generating a number of masking bit types corresponding to a number of user positions through which stations (STAs) are to be expressed.

According to another aspect of the present invention, there is provided a user identification apparatus in a multi-user wireless communication system, the apparatus including a first identification information generator to generate first identification information by reflecting masking ID information to group ID information associated with a received signal, a second identification information generator to generate second identification information based on a correspondence relationship between the generated first identification information and PGU information transferred from an available AP, and a user position determiner to determine a user position based on the generated second identification information.

The user position determiner may generate a position comparison bit based on the generated second identification information and a masking bit.

The user position determiner may determine the user position based on the generated position comparison bit.

The user identification apparatus may further include a storing unit to store and maintain the PGU information transferred from the available AP.

In the PGU information, a combination of a user position and PGU information transferred to an AP through a control frame may be expressed in a form of a bitstream.

The first identification information generator may include an operation unit to perform an n-bit shift operation on the group ID information of the received signal, a comparator to compare the masking ID information and the group ID information on which the n-bit shift operation is performed, on a bit by bit basis, and a generator to generate the first identification information based on a result of the comparing.

The second identification information generator may include a determiner to determine whether the generated first identification information is identical to the PGU information on a bit by bit basis, and generator to generate the second identification information based on a result of the comparing.

The user position determiner may verify whether “1” is present among bits included in the generated second identification information, and determine, when “1” is present, that a user position corresponding to at least one of the PGU information and the group ID information associated with the received signal is present.

The user position determiner may determine, when “1” is absent, that the user position corresponding to the PGU information and the group ID information associated with the received signal is absent, and terminate reception of a signal based on a result of the determining.

The user position determiner may generate a number of masking bit types corresponding to a number of user positions through which STAs are to be expressed.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a flowchart illustrating an example of a user identification method according to an example embodiment;

FIG. 2 is a flowchart illustrating a method of determining a user position according to an example embodiment;

FIG. 3 is a flowchart illustrating another example of a user identification method according to an example embodiment;

FIG. 4 is a diagram illustrating a user position and group identification information which may be incorporated in an STA according to an example embodiment;

FIG. 5 is a diagram illustrating a field configuration of a very high throughput-signal (VHT-SIG)-A;

FIG. 6 is a diagram illustrating a packet reception termination timing in a case in which “1” is absent in bits of second identification information; and

FIG. 7 is a block diagram illustrating a user identification apparatus in a multi-user wireless communication system according to an example embodiment.

### DETAILED DESCRIPTION

Hereinafter, example embodiments of the present invention will be described with reference to the drawings.

When it is determined a detailed description related to a related known function or configuration they may make the purpose of the present invention unnecessarily ambiguous in describing the present invention, the detailed description will be omitted here. Also, terminologies used herein are defined to appropriately describe the exemplary embodiments of the present invention and thus may be changed depending on a user, the intent of an operator, or a custom. Accordingly, the terminologies must be defined based on the following overall description of this specification. Like reference numerals refer to like elements throughout.

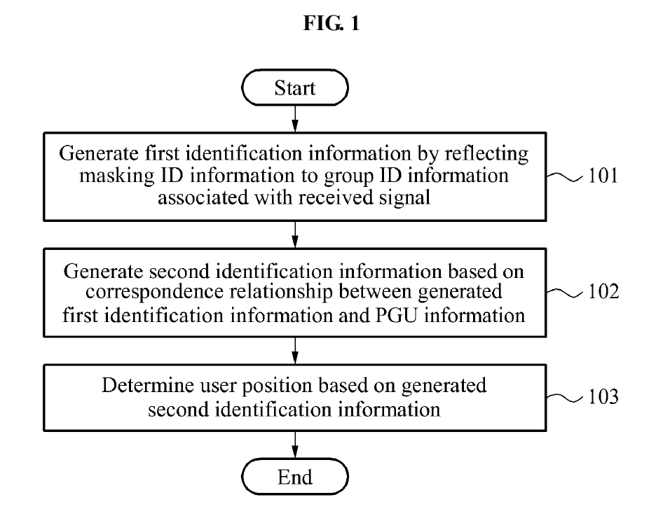

FIG. 1 is a flowchart illustrating an example of a user identification method according to an example embodiment.

In the user identification method according to an example embodiment, user identification may be performed by determining a user position.

To this end, in operation 101, first identification information may be generated by reflecting masking identification (masking ID) information to group identification (group ID) information associated with a received signal. For example, to generate the first identification information, an n-bit shift operation may be performed on the group ID information associated with the received signal. The group ID information on which the n-bit shift operation is performed may be compared to the masking ID information on a bit by bit basis, and the first identification information may be generated based on a result of the comparing.

In operation 102, second identification information may be generated based on a correspondence relationship between the generated first identification information and possible group ID (PGU) information transferred from an available access point (AP). For example, whether the generated first identification information is identical to the PGU information on a bit by bit basis may be determined, and the second identification information may be generated based on a result of the determining. Also, an & operation may be performed on the generated first identification information and the PGU information, and the second identification information may be generated based on a result of the performing.

In operation 103, the user position may be determined based on the generated second identification information.

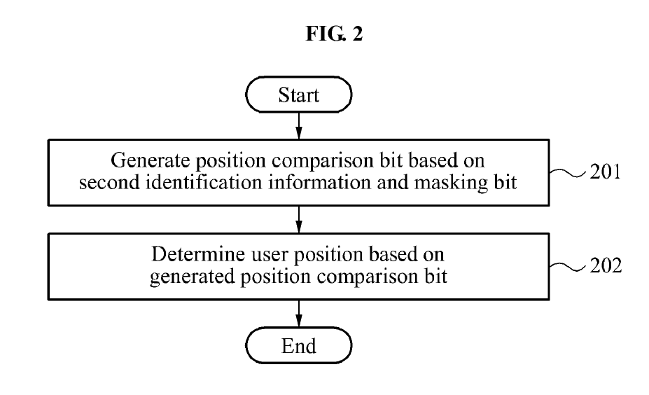

FIG. 2 is a flowchart illustrating a method of determining a user position according to an example embodiment.

Referring to FIG. 2, in operation 201, a position comparison bit may be generated based on second identification information and a masking bit to determine the user position. In operation 202, the user position may be determined based on the generated position comparison bit.

For example, the user position may be determined by verifying whether “1” is present in bits included in the second identification information. When “1” is present in the bits, the user position corresponding to at least one of PGU information and Group ID information associated with a received signal may be determined to be present. When “1” is absent in the bits, the user position corresponding to the PGU information and the Group ID information associated with the received signal may be determined to be absent. Based on a result of the determining, signal reception may be terminated.

To determine the user position based on the second identification information, a number of masking bit types corresponding to a number of user positions through which stations (STAs) are to be expressed may be generated. For example, when four user positions corresponding to a single group are present, four types of masking bits may be provided.

In the user identification method according to an example embodiment, PGU information transferred from an available AP may be stored and maintained. For example, in the PGU information, a combination of a user position and PGU information transferred to an AP through a control frame may be stored in a form of a bitstream.

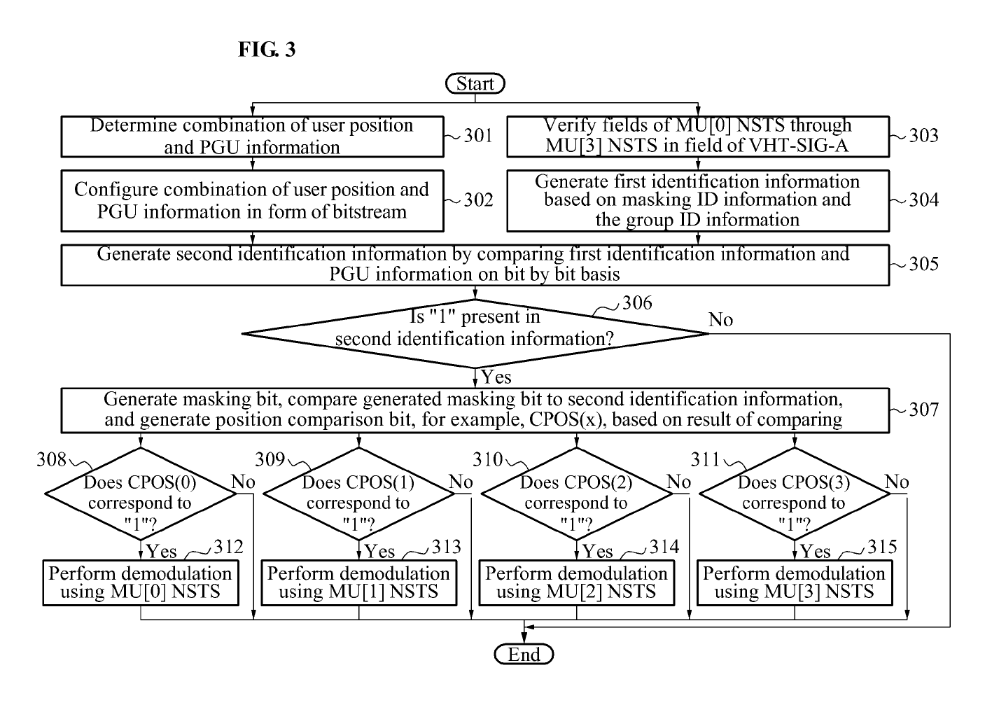

FIG. 3 is a flowchart illustrating another example of a user identification method according to an example embodiment.

In operation 301, a combination of a user position and PGU information transferred from an available AP through a control frame may be determined.

In operation 302, the combination of the user position and the PGU information transferred from the AP through the control frame may be configured in a form of a bitstream not using a memory.

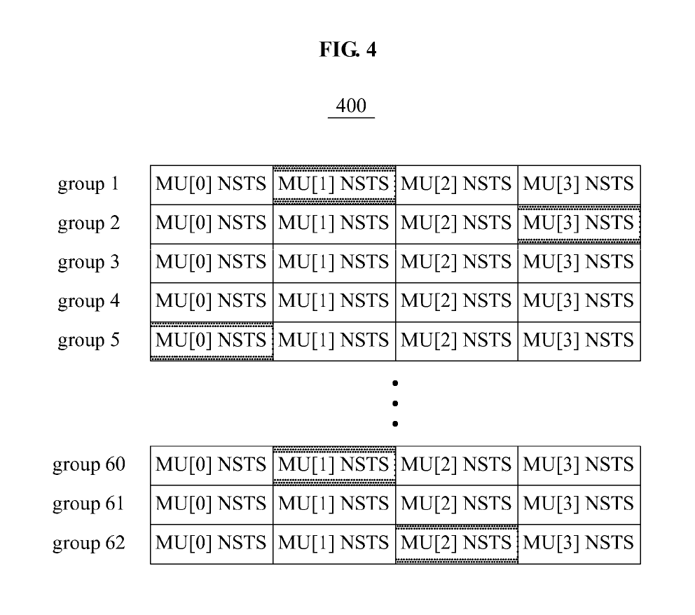

FIG. 4 is a diagram illustrating a user position and group identification information which may be incorporated in an STA according to an example embodiment. Referring to FIG. 4, a user position and group ID information which may be incorporated in an STA may be arranged on a table 400 to be bitmapped. The STA may be included in a plurality of groups, for example, group 1, group 2, group 5, . . . , group 60, and group 62, and may have a different user position for each of the groups.

For example, when a combination of a user position U[x] and group ID information G[x] transferred from an AP through a control frame is G[1]-U[3], G[10]-U[1], G[25]-U[0], G[32]-U[2], G[43]-U[0], and G[61]-U[3], the combination may be expressed in a bitstream having 256 bits. In this example, group 0 and group 63 corresponding to a single user may be incorporated.

PGU information may indicate a combination of a user position and group ID information transferred from an AP through a control frame, in a form of a bitstream as shown below.

PGU=0x0080_{—}0000_{—}0000_{—}0000_{—}0000_{—}1000_{—}0000_{—}0004_{—}0000_{—}0010_{—}0000_{—}0000_{—}0000_{—}0200_{—}0000_{—}0080

The PGU information may be expressed by a hexadecimal number, and may be in a form in which group ID information provided farthest to the right is “0” and group ID information provided farthest to the left is ascending. Each of the four bits configuring the hexadecimal number may indicate the user position. For example, the four bits may be expressed as 0001 when the user position is U[0], 0010 when the user position is U[1], 0100 when the user position is U[2], and 1000 when the user position is U[3].

In the user identification method according to an example embodiment, MU[0] number of space time streams (NSTS) through MU[3] NSTS and group ID information of a field may be verified with respect to a packet transmitted through a cyclic redundancy check (CRC) by receiving a very high throughput-signal (VHT-SIG)-A.

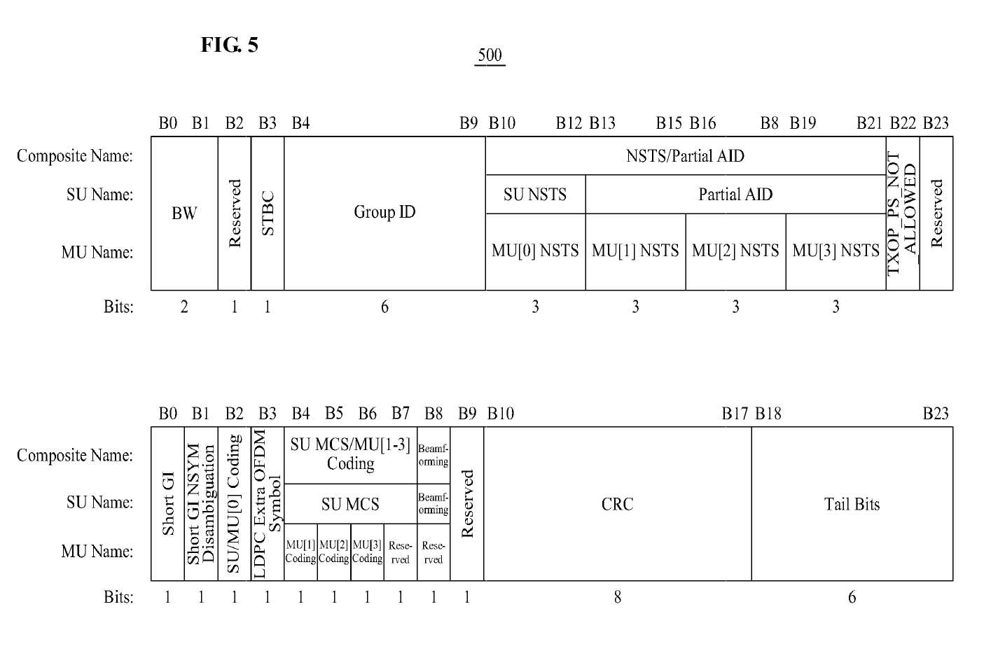

FIG. 5 is a diagram illustrating a field configuration of a VHT-SIG-A 500 used to implement multi-user transmission.

For increased clarity and conciseness, descriptions of an example embodiment will be provided using the VHT-SIG-A 500, and may be applied to another format of a signal.

When the multi-user transmission is performed using the VHT-SIG-A 500, an STA may verify whether a packet is to be transmitted to the STA by comparing an NSTS and a group in which the STA is included, based on information associated with MU[3] NSTS through M[0] NSTS of B21 through B10, and group ID information associated with B9 through B4.

For example, when group ID information on the group in which the STA is “38” and a position in the corresponding group is MU[1], the STA may verify that the packet is not to be transmitted to the STA and suspend demodulation in a case in which group ID information of the received VHT-SIG-A 500 is not “38”. When the group ID information of the received VHT-SIG-A 500 is “38”, the STA may initiate the demodulation of a packet based on a user position by acquiring a position determined in a group.

The STA supporting the multi-user transmission may be allowed to have groups 1 through 62, and NSTSs to be positioned in each of the groups may be one of four. Each of group ID information 0 and group ID information 63 may indicate a single user. The STA may be aware of a user position and group ID information on a group in which the STA is included, by exchanging an initial control frame to an AP.

When a signal having a VHT presentation protocol data unit (PPDU) format is received, the STA may compare received group ID information and group ID information on a group in which the STA is included, which is transferred from an AP through a control frame, and may simultaneously verify a user position in consideration of a case of receiving the group ID information on the group in which the STA is included. The STA may have 64 items of group ID information including a single user. To classify all of the items in consideration of the user position, the STA may need to perform comparisons simultaneously or sequentially. An aspect of the present invention may be provided to solve an issue of increasing hardware latency, requiring a verification time when sequential comparison is performed while a number of comparators increases when simultaneous comparison is performed.

Referring back to FIG. 3, in the user identification method, four-bit shift may be performed on received group ID information so as to be compared to the PGU information. In operation 303, fields of MU[0] NSTS through MU[3] NSTS may be verified from a field of the VHT-SIG-A 500. In operation 304, first identification information may be generated by comparing masking ID information and the group ID information on which the four-bit shift is performed, on a bit by bit basis.

The masking ID information may be expressed as shown below.

MID=0x0000_{—}0000_{—}0000_{—}0000_{—}0000_{—}0000_{—}0000_{—}0000_{—}0000_{—}0000_{—}0000_{—}0000_{—}0000_{—}0000_{—}000f

In operation 305, second identification information may be generated by comparing the first identification information and the PGU information on the bit by bit basis. As an example, the second identification information may be generated by performing an & operation on the PGU information and the first identification information on the bit by bit basis.

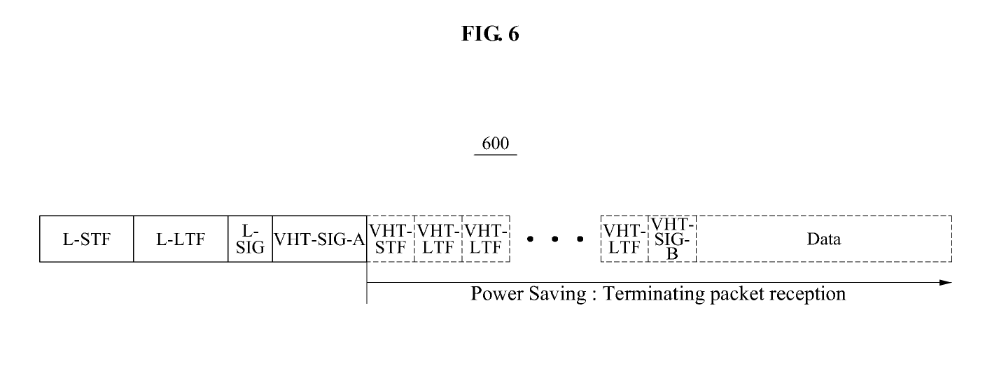

In operation 306, whether “1” is present in the generated second identification information may be determined. For example, based on a result of the determining of operation 306, the user position may be determined to be present in the PGU information and received group ID information when “1” is present in 256 bits second identification information. When “1” is absent, the user position may be determined to be absent, and reception may be terminated as shown in FIG. 6.

FIG. 6 is a diagram illustrating a packet reception termination timing 600 in a case in which “1” is absent in bits of second identification information.

When “1” is determined to be present in the second identification information, in operation 307, a masking bit may be generated and compared to the second identification information, thereby generating position comparison bit, for example, CPOS(x), based on a result of the comparing. In this example, the CPOS(x) may correspond to information indicating a user position in group ID information on a corresponding group.

When the position comparison bit is determined, a packet may be demodulated based on an NSTS of a corresponding position among MU[3] NSTS through MU[0] NSTS of VHT-SIG-A. To this end, whether CPOS(0) corresponds to “1”, whether CPOS(1) corresponds to “1”, whether CPOS(2) corresponds to “1”, and whether CPOS(3) corresponds to “1” may be determined through operations 308 to 311.

Whether CPOS(0) corresponds to “1” may be determined by determining whether the user position corresponds to MU[0] in the group ID information on the corresponding group. Whether CPOS(1) corresponds to “1” may be determined by determining whether the user position corresponds to MU[1] in the group ID information on the corresponding group. Whether CPOS(2) corresponds to “1” may be determined by determining whether the user position corresponds to MU[2] in the group ID information on the corresponding group. Whether CPOS(3) corresponds to “1” may be determined by determining whether the user position corresponds to MU[3] in the group ID information on the corresponding group.

When CPOS(0) corresponds to “1”, a signal may be demodulated based on MU[0] NSTS in operation 312.

When CPOS(1) corresponds to “1”, a signal may be demodulated based on MU[1] NSTS in operation 313. When CPOS(2) corresponds to “1”, a signal may be demodulated based on MU[2] NSTS in operation 314. When CPOS(3) corresponds to “1”, a signal may be demodulated based on MU[3] NSTS in operation 315.

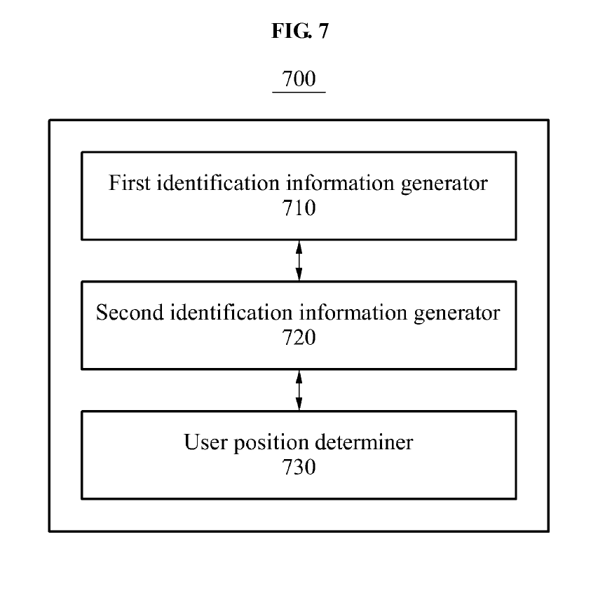

FIG. 7 is a block diagram illustrating a user identification apparatus 700 in a multi-user wireless communication system according to an example embodiment.

The user identification apparatus 700 may determine a user position within four cycles when a number of groups is “64” and four user positions are included for each of the groups. For increased clarity and conciseness, descriptions of example embodiments will be provided based on a case in which 64 groups, each including four user positions are provided, and may be applied to a system having a different number of groups, each including a different number of user positions.

The user identification apparatus 700 according to an example embodiment may include a first identification information generator 710, a second identification information generator 720, and a user position determiner 730.

The first identification information generator 710 may generate first identification information by reflecting masking identification (masking ID) information to group identification (group ID) information associated with a received signal.

For example, the first identification information generator 710 may include an operation unit to perform an n-bit shift operation on the group ID information of the received signal, a comparator to compare the masking ID information and the group ID information on which the n-bit shift operation is performed, on a bit by bit basis, and a generator to generate the first identification information based on a result of the comparing.

The second identification information generator 720 may generate second identification information based on a correspondence relationship between the generated first identification information and PGU information transferred from an available AP.

For example, the second identification information generator 720 may include determiner to determine whether the generated first identification information is identical to the PGU information on a bit by bit basis and generator to generate the second identification information based on a result of the comparing.

The user position determiner 730 may determine a user position based on the generated second identification information. The user position determiner 730 may generate a position comparison bit based on the generated second identification information and a masking bit. For example, the user position determiner 730 may determine the user position based on the generated position comparison bit.

As an example, the user identification apparatus 700 may also include a storing unit to store and maintain the PGU information transferred from the available AP. In this example, in the PGU information, a combination of a user position and PGU information transferred to an AP through a control frame may be expressed in a form of a bitstream.

The user position determiner 730 may verify whether “1” is present among bits included in the generated second identification information, and determine that a user position corresponding to at least one of the PGU information and the group ID information associated with the received signal is present when “1” is present. When “1” is absent, the user position determiner 730 may determine that the user position corresponding to the PGU information and the group ID information associated with the received signal is absent. When the corresponding user position is determined to be absent, the user position determiner 730 may terminate reception of a signal.

The user position determiner 730 may generate a number of masking bit types corresponding to a number of user positions through which stations are to be expressed.

Accordingly, technology for determining a user position and comparing group ID information used for packet demodulation and power consumption reduction of an STA supporting multiple users may be provided.

According to an aspect of the present invention, it is possible to provide technology to determine a user position and compare group ID information for packet demodulation and reducing power consumption in an STA supporting multiple users.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy discs, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A user identification method in a multi-user wireless communication system, the method comprising:
generating first identification information by reflecting masking identification (ID) information to group ID information associated with a received signal;
generating second identification information based on a correspondence relationship between the generated first identification information and possible group ID (PGU) information transferred from an available access point (AP); and
determining a user position based on the generated second identification information.

2. The method of claim 1, wherein the determining comprises generating a position comparison bit based on the generated second identification information and a masking bit.

3. The method of claim 2, wherein the determining further comprises determining the user position based on the generated position comparison bit.

4. The method of claim 1, further comprising:
storing and maintaining the PGU information transferred from the available AP.

5. The method of claim 4, wherein the storing comprises storing a combination of a user position and PGU information transferred to an AP through a control frame, in a form of a bitstream.

6. The method of claim 1, wherein the generating of the first identification information comprises:
performing an n-bit shift operation on the group ID information associated with the received signal;
comparing the masking ID information and the group ID information on which the n-bit shift operation is performed, on a bit by bit basis; and
generating the first identification information based on a result of the comparing.

7. The method of claim 1, wherein the generating of the second identification information comprises:
determining whether the generated first identification information is identical to the PGU information on a bit by bit basis; and
generating the second identification information based on a result of the comparing.

8. The method of claim 1, wherein the determining comprises:
verifying whether “1” is present among bits comprised in the generated second identification information; and
determining, when “1” is present, that a user position corresponding to at least one of the PGU information and the group ID information associated with the received signal is present.

9. The method of claim 8, wherein the determining comprises:
determining, when “1” is absent, that the user position corresponding to the PGU information and the group ID information associated with the received signal is absent, and terminating reception of a signal based on a result of the determining.

10. The method of claim 2, wherein the determining further comprises generating a number of masking bit types corresponding to a number of user positions through which stations (STAs) are to be expressed.

11. A user identification apparatus in a multi-user wireless communication system, the apparatus comprising:
a first identification information generator to generate first identification information by reflecting masking identification (masking ID) information to group identification (group ID) information associated with a received signal;
a second identification information generator to generate second identification information based on a correspondence relationship between the generated first identification information and possible group ID (PGU) information transferred from an available access point (AP); and
a user position determiner to determine a user position based on the generated second identification information.

12. The apparatus of claim 11, wherein the user position determiner generates a position comparison bit based on the generated second identification information and a masking bit.

13. The apparatus of claim 12, wherein the user position determiner determines the user position based on the generated position comparison bit.

14. The apparatus of claim 11, further comprising:
a storing unit to store and maintain the PGU information transferred from the available AP.

15. The apparatus of claim 14, wherein, in the PGU information, a combination of a user position and PGU information transferred to an AP through a control frame is expressed in a form of a bitstream.

16. The apparatus of claim 11, wherein the first identification information generator comprises:
an operation unit to perform an n-bit shift operation on the group ID information of the received signal;
a comparator to compare the masking ID information and the group ID information on which the n-bit shift operation is performed, on a bit by bit basis; and
a generator to generate the first identification information based on a result of the comparing.

17. The apparatus of claim 11, wherein the second identification information generator comprises:
determiner to determine whether the generated first identification information is identical to the PGU information on a bit by bit basis; and
generator to generate the second identification information based on a result of the comparing.

18. The apparatus of claim 11, wherein the user position determiner verifies whether “1” is present among bits comprised in the generated second identification information, and
determines, when “1” is present, that a user position corresponding to at least one of the PGU information and the group ID information associated with the received signal is present.

19. The apparatus of claim 18, wherein the user position determiner determines, when “1” is absent, that the user position corresponding to the PGU information and the group ID information associated with the received signal is absent, and
terminates reception of a signal based on a result of the determining.

20. The apparatus of claim 12, wherein the user position determiner generates a number of masking bit types corresponding to a number of user positions through which stations (STAs) are to be expressed.
